(19) United States
(12) Patent Application Publication
(10) Pub. No.: US 2009/0224875 A1
(43) Pub. Date: Sep. 10, 2009

(54) System for preventing theft of articles from an enclosure

(75) Inventors: Alan Rabinowitz, Long Valley, NJ (US); Robert Joyce, Mechanicsburg, PA (US)

Correspondence Address: EPSTEIN DRANGEL BAZERMAN & JAMES, LLP, 60 EAST 42ND STREET, SUITE 820, NEW YORK, NY, 10165, US

(73) Assignee: Vira Manufacturing, Inc.

(21) Appl. No.: 12/380,611

(22) Filed: Mar. 2, 2009

Related U.S. Application Data
(60) Provisional application No. 61/068,355, filed on Mar. 6, 2008.

(51) Int. Cl. G05B 19/00

(52) U.S. Cl. 340/5.53; 340/5.6; 340/5.52

(57) ABSTRACT

The security system prevents theft of articles from an enclosure having a lockable access opening. Using RFID technology, a transponder periodically scans the enclosed display area to interrogate RFID tags associated with each of the articles within the enclosure. Access to the enclosure is controlled by an electronically activated retrofit lock associated with the access opening. Biometric technology is used to identify an individual attempting to access the enclosure and to determine whether the identified individual is authorized to access the enclosure. If the individual is authorized, the identity of the authorized individual, the identity of an article removed from the enclosure, and the time that the article was removed from the enclosure are recorded. A POS/inventory control system notes the sale of the removed article. A security alert signal is generated if the removed article is not sold or returned to the enclosure within a given time period after the article was removed from the enclosure. Images of the area proximate the enclosure may be captured by a closed circuit video camera and stored.

### CROSS-REFERENCE TO RELATED APPLICATIONS

Priority is claimed on Provisional Patent Application Ser. No. 61/068,355, filed Mar. 6, 2008.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to anti-theft systems and more particularly to a security system for preventing theft of articles from an enclosure such as a merchandise display case, stockroom or warehouse.

2. Description of Prior Art Including Information Disclosed Under 37 CFR 1.97 and 1.98

A recent survey of top domestic retailers concerning chain wide item shrinkage revealed losses exceeding $46 billion. One major retailer alone cited locked showcase product losses in excess of $2 billion. These numbers are steadily increasing and are believed to be mainly attributable to employee theft.

There is a great need for a security detection and loss prevention system which can automatically identify individuals removing articles from enclosed areas such as display cases, stock rooms or warehouses, tracking the removed articles to determine if they are sold to customers and providing security alerts if unsold articles are not replaced in the enclosed area within a predetermined time period. The present invention is such a system.

In its preferred form, the system of the present invention combines biometrics, Wi-Fi, and RFID technology to provide keyless solutions that involve metrics, asset management, asset security and forensic tools to prevent such losses. The system extends beyond the sales floor and displays into the warehouse and stock room. It reduces or eliminates both employee and consumer theft.

It is a prime object of the present invention to provide a security system for preventing theft of articles from an enclosure.

It is another object of the present invention to provide a security system for preventing theft of articles from an enclosure that utilizes biometrics to identify individuals authorized to access the enclosure.

It is another object of the present invention to provide a security system for preventing theft of articles from an enclosure that records the identity of individuals accessing an enclosure, the articles removed from the enclosure and the times each article is removed.

It is another object of the present invention to provide a security system for preventing theft of articles from an enclosure that generates a security alarm if a removed article is not sold or returned to the enclosure within a predetermined time period.

It is another object of the present invention to provide a security system for preventing theft of articles from an enclosure that interfaces with closed circuit camera systems which record images of the area proximate the enclosure as well as time and date the images are recorded to permit security personnel to ascertain the identity of individuals responsible for the theft and for purposes of prosecuting the responsible individuals.

It is another object of the present invention to provide a security system for preventing theft of articles from an enclosure that may be is retrofitted to existing enclosures, such as display cases with drawers or sliding doors, and stock rooms or warehouses with hinged or sliding doors.

It is another object of the present invention to provide a security system for preventing theft of articles from an enclosure that utilizes a locking system that cannot easily be defeated.

It is another object of the present invention to provide a security system for preventing theft of articles from an enclosure that utilizes a keyless entry with requires positive identification of individuals accessing the enclosure.

It is another object of the present invention to provide a security system for preventing theft of articles from an enclosure that generates a time and date stamp each time the enclosure is accessed.

It is another object of the present invention to provide a security system for preventing theft of articles from an enclosure that creates a history for each article in the enclosure that includes information as to each time the article is removed from or returned to the case, and if the article is sold.

It is another object of the present invention to provide a security system for preventing theft of articles from an enclosure that utilizes a RFID system to record and track enclosure inventory.

It is another object of the present invention to provide a security system for preventing theft of articles from an enclosure that interfaces with a POS/inventory control system to record the sale of an article.

It is another object of the present invention to provide a security system for preventing theft of articles from an enclosure that can provide marketing data on product activity, such as consumer interest and purchasing.

It is another object of the present invention to provide a security system for preventing theft of articles from an enclosure in which the system electronics can reside in the kick base area of a display enclosure so as not to reduce the interior space of the display enclosure.

It is another object of the present invention to provide a security system for preventing theft of articles from an enclosure that is capable of wirelessly transmitting a security alert to a remote location when an article is stolen.

### BRIEF SUMMARY OF THE INVENTION

The above objects are achieved by the system of the present invention, which includes apparatus for preventing theft of articles from an enclosure of the type having a lockable access opening. The apparatus includes means for sensing the presence of each of the articles within the enclosure; means for controlling access to the enclosure; means for identifying an individual attempting to access the enclosure; means for determining whether the identified individual is authorized to access the enclosure; means for recording the identity of the authorized individual, the identity of an article removed from the enclosure, and the time that the article was removed; means for recording the sale of the removed article, if the removed article is sold; and means for generating a security alert signal if the removed article is not sold or returned to the enclosure within a given time period after the article was removed from the enclosure.

The apparatus further includes video means for recording images of the area proximate the enclosure; and means for activating the video means to store the images recorded by the video means.

The article sensing means includes a RFID tag associated with each article to be monitored, means for identifying each article present in the enclosure by reading the RFID tag associated with the article and means for recoding the identity of an article removed from the enclosure and the time that the article was removed.

The controlling means includes means for locking the enclosure, and means for deactivating the locking means upon determining that the individual attempting to access the enclosure is authorized to access the enclosure. The locking means automatically relocks the enclosure after the removal of an article.

The identifying means preferably includes biometric means. The biometric means preferably includes a fingerprint reader.

The means for recording the sale of the removed article includes means for identifying the article being sold.

The security alert signal generating means includes timing means for monitoring the time an article has been absent from the enclosure.

The apparatus further includes means for transmitting the security alert signal to a remote location. Preferably, the transmitting means transmits the security alarm signal wirelessly.

The recording means also includes means for recording indicia associated with an article returned to the enclosure and the time that the article was returned to the enclosure.

In accordance with another aspect of the present invention, a method is provided for preventing theft of articles from an enclosure of the type having a lockable access opening. The method includes the following steps:
sensing the presence of each of the articles within the enclosure;
controlling access to the enclosure;
identifying an individual attempting to access the enclosure;
determining whether the identified individual is authorized to access the enclosure;
recording the identity of the authorized individual, the identity of an article removed from the enclosure, and the time that the article was removed from the enclosure;
recording the sale of the removed article, if the removed article is sold; and
generating a security alert signal if the removed article is not sold or returned to the enclosure within a given time period after the article was removed from the enclosure.

The method further includes the steps of:
recording images of the area proximate the enclosure; and
storing the images recorded.

The step of sensing the presence of the articles comprises the steps of: associating a RFID tag with each article within the enclosure; identifying each article present in the enclosure by reading the RFID tag associated with the article; and recoding the identity of an article removed from the enclosure and the time that the article was removed.

The step of controlling access to the enclosure includes the steps of: permitting access to the enclosure upon determining that the individual attempting to access the enclosure is authorized to access the enclosure.

The method further includes the step of relocking the enclosure after the removal of an article from the enclosure.

The step of identifying an individual includes the step of identifying the individual using biometrics.

The step of using biometrics includes reading the fingerprint of the individual.

The step of recording the sale of the removed article includes the step of identifying a removed article that is sold.

The step of generating a security alert signal includes the step of monitoring the time from the removal of the article from the enclosure.

The method further includes the step of transmitting the security alert signal to a remote location. Preferably, the signal is transmitted wirelessly.

The step of recording further includes the step of recording indicia associated with an article returned to the enclosure and the time that the article was returned to the enclosure.

### BRIEF DESCRIPTION OF THE SEVERAL VIEWS OF DRAWINGS

To these and to such other objects that may hereinafter appears, the present invention relates to a security system for preventing theft of articles from an enclosure as described in detail in the following specification and recited in the annexed claims, taken together with the accompanying drawings, in which like numerals refer to like parts and in which:

FIG. 1 is an environments view of a display case in a retail store with the security system of the present invention installed;

FIG. 2 is a view of a bracelet with an RFID tag as it would appear inside the drawer of the display;

FIG. 3 is a partial view of a necklace with an RFID tag as it would appear outside the display case;

FIG. 4 is a block diagram showing the main components of the security system of the present invention;

FIG. 5 illustrated the use of the security system of the present invention with a conventional computerized POS/inventory control system and a conventional closed circuit security video camera system and how the security system of the present invention interfaces with those systems;

FIG. 6 is a view similar to FIG. 5 showing the security system generating a security alarm; and

FIG. 7 is a flow chart illustrating the method of operation of the present invention.

### DETAILED DESCRIPTION OF THE INVENTION

The following is a description of a preferred embodiment of the present invention as it might be implemented to protect two jewelry articles in an enclosed display case of a retail store. The description is intended to describe the operation of the system of the present invention in its simplest form and should not be considered as a limitation on the invention, which can take many other forms and be used in different environments.

For example, enclosures other than merchandise display cases can be protected by the system, such as show rooms and warehouses to which access is controlled. Many more articles than two can be protected at the same time. The system can interface with various types of computerized point of sale (POS)/inventory control systems. Further, the system can include a closed circuit television system or interface with a preexisting closed circuit television system.

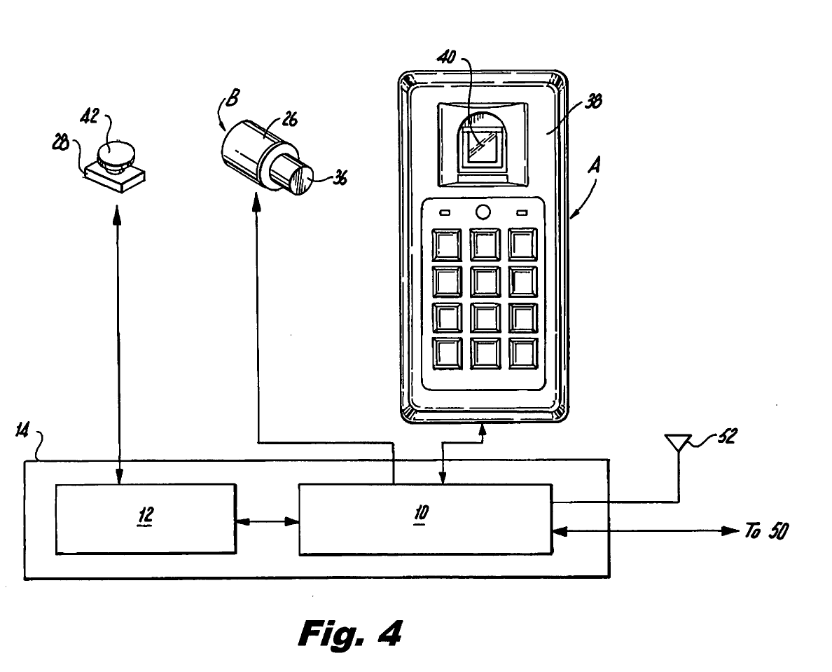

As seen in FIG. 4, the security system of the present invention includes a central electronic control unit 10 and an RFID transducer control unit 12. The central control unit 10 and the RFID transducer control unit 12 are preferably situated within a box 14 placed in a hidden and secure location, such as the kick base 16 of a display case 18.

The system includes means, generally designated A, for identifying an individual seeking access to an enclosure (in this example, a drawer 20 in display case 18) which contains one or more articles to be monitored, such as a bracelet 22 and a necklace 24.

The system also includes a means, generally designated B, for controlling access to drawer 20. In this example, means B takes the form of an electronically controlled locking device including a solenoid 26. When solenoid 26 is activated, an authorized individual can access the enclosure by sliding drawer 20 out of the display case 18 to remove or replace a monitored article.

Further, the system includes a means, generally designated C, for detecting the presence of a monitor article within the drawer. Means C is preferably a RFID tracking system that includes a RFID transducer 28 controlled by transducer control unit 12. Transducer 28 is preferably mounted immediately beneath the bottom surface of drawer 20, as illustrated in FIG. 2. As seen in FIGS. 2 and 3, the articles to be monitored are provided with RFID tags 30 attached thereto by an anti-theft attachment commonly used to prevent tag switching.

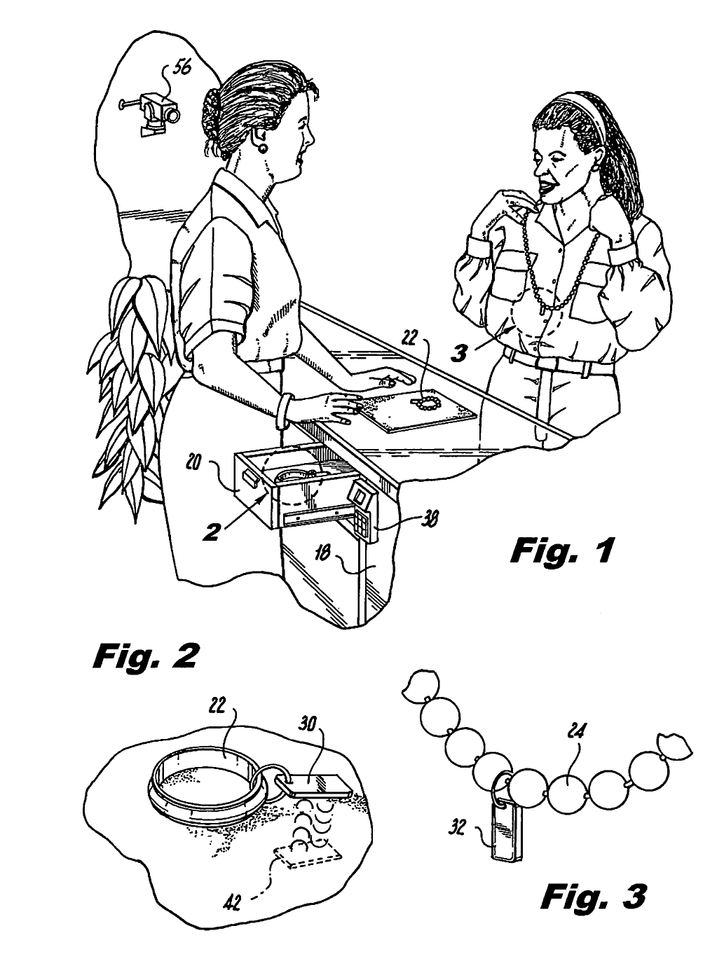

As seen in FIG. 1, the security system of the present invention may be situated in a display case 18 which includes an opaque base cabinet with a lower compartment 32 and an upper compartment 34 within which drawer 20 is situated. The top surface of case 18 is transparent so as to form display area in which a customer, such as the women trying on necklace 24, may view the article within drawer 20 without having access to them.

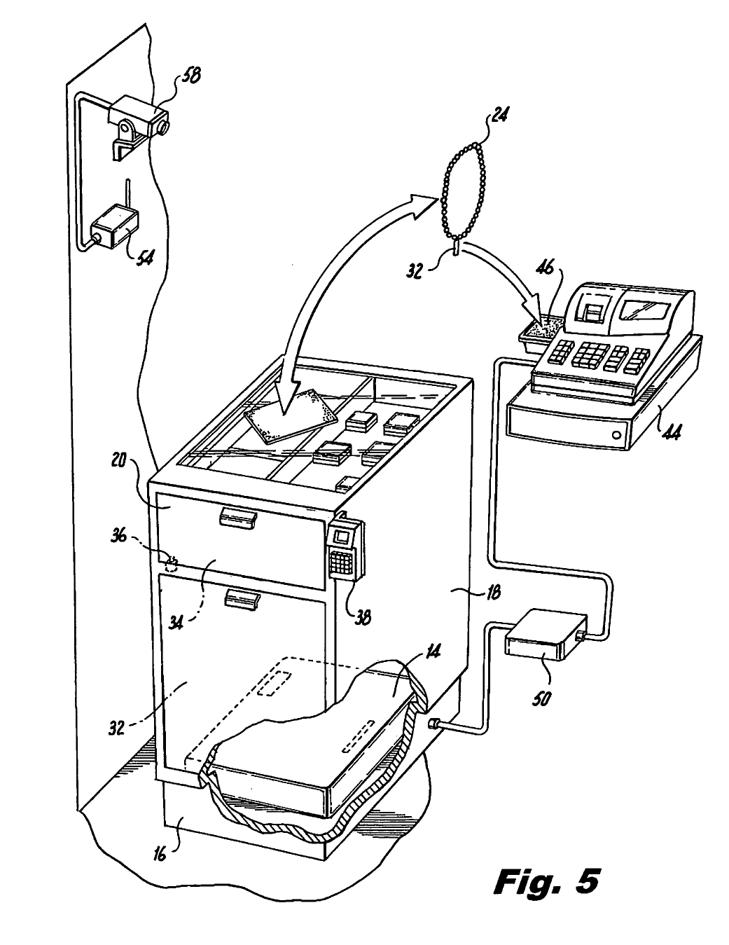

The display area within the drawer is completely enclosed while drawer 20 remains closed, as shown in FIG. 5. When drawer 20 is in its open position, as seen in FIG. 1, the salesperson, shown behind the display case, may access the contents of the drawer and remove articles from the drawer or place article into the drawer.

Movement of drawer 20 from the closed position to the open position is controlled by lock means B, which is retrofitted into the case.

The lock means includes an electrically controlled solenoid 26 with a moveable plunger 36. The solenoid is situated within lower cabinet 32, under drawer 20, such that plunger 36 interferes with the movement of the door when it is in its extended position, thereby preventing the opening of the drawer and hence access to the enclosed area. Solenoid 26 is responsive to command signals from the control unit 10.

Preferably, plunger 36 of solenoid 26 is normally in its extended (“locked”) position. The solenoid has an internal spring (not shown) that urges the plunger towards its locked position. Absent the appropriate signal from control unit 10, the extended plunger 36 prevents the drawer from being moved to the open position to permit access to the display area.

Upon receipt of the appropriate command signal from control unit 10, solenoid 26 is energized to move plunger 36 against the internal spring to a withdrawn position (“unlocked”) remote from drawer 20 such that the drawer can be moved to the open position and the display area 14 can be accessed. Once the command signal from control unit 10 ceases and the drawer is returned to the closed position, plunger 36 is moved back to its “lock” position by the internal spring, such that the drawer cannot be reopened until another command signal is received, that is, the display area is relocked.

Also connected to control unit 10 is a fingerprint reader 38. Fingerprint reader 36 is preferably located on the back or side of the display case, as seen in FIGS. 1, 5 and 6 so that it can be easily accessed by an employee. In order to activate solenoid 26 to allow entry into the display area by moving drawer 20 to the open position, an individual wishing to gain access must place his or her finger onto pad 40 of fingerprint reader 38. Reader 38 reads the fingerprint of the individual and compares same to the fingerprints of authorized individuals, previously stored in the fingerprint reader.

If there is a match, meaning that the individual seeking access to the display case is authorized to do so, reader 38 generates a signal to control unit 10 which, in turn, causes control unit 10 to generate a command signal to solenoid 26 that causes plunger 36 to withdraw from the plane of the drawer, such that the drawer can be moved to the open position and the interior of the display case can be accessed. If there is no match, no command signal will be generated and the solenoid plunger will continue to prevent the drawer from being moved to the open position. The drawer of the display case cannot be opened until the fingerprint of an authorized individual is read.

RFID transponder 28 is connected to control unit 12 and includes an antenna 42 located immediately below drawer 20. Each of the articles 22, 24 is provided with a RFID tag 32 affixed thereto. When the system is initiated, and periodically thereafter, unit 12 causes transponder 28 to scan the drawer and interrogates the RFID tag 32 associated with each article in the drawer to be monitored. The transponder identifies each article in the drawer associated with a tag and stores same in an electronic memory within control unit 10, for example by recording its SKU, as well as the time and date that the scan took place, so as to form and maintain an inventory of each article in the drawer through time.

When fingerprint reader 38 reads the fingerprint of an individual authorized to access the display case, the identity of that individual is also recorded in the memory within control unit 10 and the control unit generates a command signal to solenoid 26 to withdraw plunger 36 such that drawer 20 may be moved to the open position by the authorized individual. When an article (for example, necklace 24) is removed from the now accessible display area, the absence of the removed article is sensed by transponder 28 during the next scan and the time and date of same is recorded in the control unit memory, and associated with the identity of the individual authorized to access the display case.

Further, upon detection of the removal of an article from the display case, a timer within control unit 10 is started so as to track the time from the removal of the article from the display case. If more than one article is removed from the display case, a record of the identity of the individual authorized to access the case, the identity of each article removed and the time and date of removal of each article is recorded. A separate timer monitoring the time from the removal of each article is started to track the period after removal of that article.

As is illustrated in the drawings, the security system of the present invention is designed to interface with a computerized Point of Sale (POS)/inventory system. The POS system includes a means of ascertaining the identity of each article sold, such as by recording the SKU of the article. That means could be an electronic cash register 44 with a product code scanner 46 or other sale recording device connected to the inventory control circuitry 50 of the POS system. Upon recording a sale of an article with the SKU of the article removed from the display case, the POS system notifies control unit 10 of the security system of the time and date of the sale. See FIG. 5.

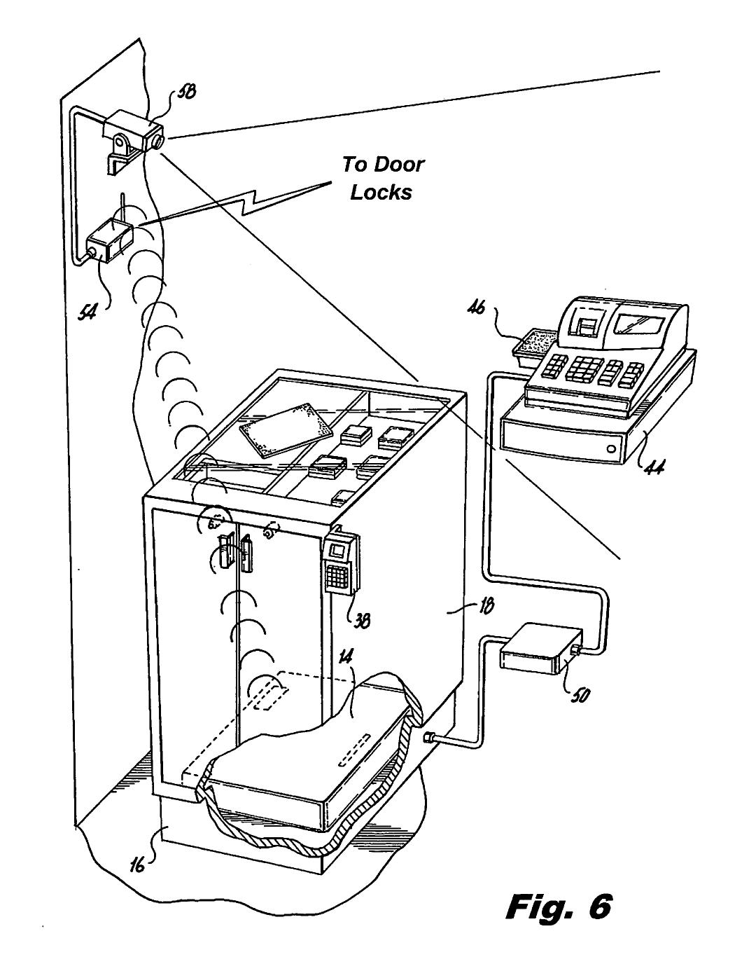

If the sale of an article with the SKU of the removed article is recorded within a predetermined time period, as monitored by the timer in the control unit 10, no action is taken by the security system. However, if such a sale is not recorded within the predetermined time period, indicating that the removed article has not been sold, and the article in question has not been returned to the display case by the end of the time period, as determined by the periodic scanning of all RDIF tags within the display area, control unit generates a security alarm signal. See FIG. 6.

Preferably, the security alarm signal is transmitted wirelessly via an antenna 52, using Wi-Fi or other conventional technology, to a receiver 54 in a remote location, such as the store security command center so that security personnel are alerted to the theft. The security system of the present invention is designed for use with video surveillance equipment, such as the closed circuit video surveillance camera 56, which monitors the area proximate the display case. Camera 58 automatically stores a record of the images of the viewed area capture from the time the timer associated with the missing article was started until the alarm signal was generated, stamps the record with the start and end time, and the date> The system may then sends the images to the security control center. The system can also be set up to automatically lock the exit doors, if desired.

In the event of a security alert signal being transmitted, indicating that an article has been stolen, the images recorded by the video camera can be reviewed to determine who is responsible for the theft. Those images can later be used to convict a perpetrator in court.

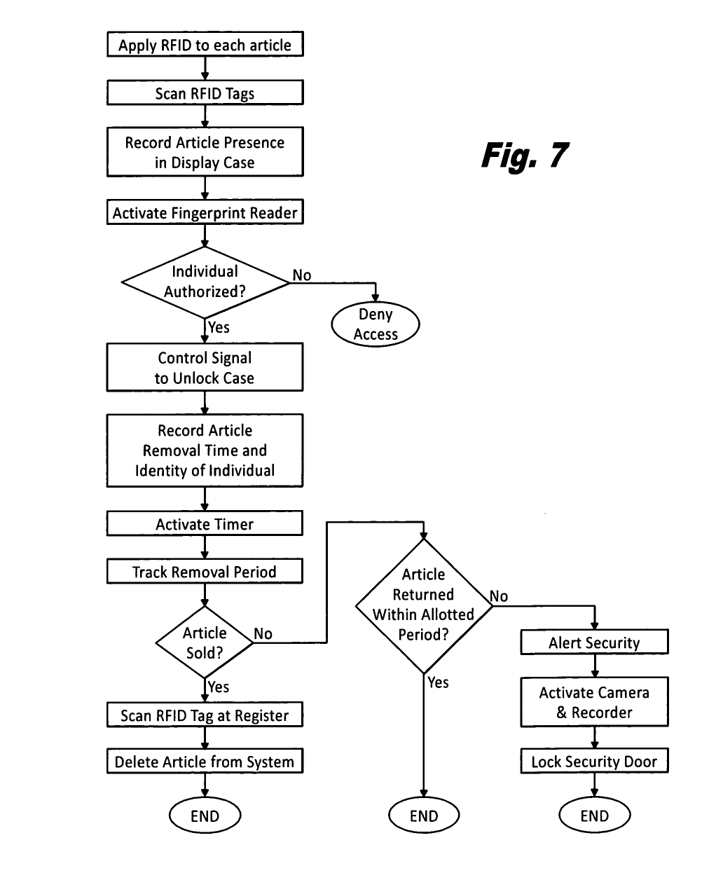

FIG. 7 illustrates the operation of the security system in flow chart form. After attaching a RFID tag to each article to be monitored, the articles are placed in the enclosed area (e.g. the drawer) and the enclosed area is locked by the solenoid lock. The system is then activated and the RFID transponder scans the drawer and records the identity of each article in the drawer.

Upon activating the fingerprint reader by placing a finger on the pad on front of the reader, a decision is made as to whether the individual is authorized to access the enclosed area. If the individual is authorized, a control signal is generated by control unit 10 causing the solenoid to withdraw the plunger to permit the drawer to be opened and one or more articles to be removed from the drawer. The drawer is then closed and automatically relocked.

During the next scan, which occurs very few seconds, the identity of the removed article is recorder and associated with the identity of the individual authorized to access the enclosure. A time associated with the removed article is stored. The period of removal, as tracked by the timer, is monitored.

Prior to the end of a predetermined time, if the POS/inventory control system has recorded a sale of the article in question or if the article has been returned to the display case, the control unit notes same and causes the system to automatically reset. However, if by the end of the period, the article is neither sold nor returned to the display case, the security alert signal is generated, the images within the security camera for the time period in question are stored, along with the time and date and the exit door may be locked.

It will now be appreciated that the present invention relates to a security system for preventing theft of articles from an enclosure that utilizes a biometrically operated replacement lock to control access to the enclosure. It maintains an inventory of articles using RFID technology and interfaces with a conventional computerized POS/inventory control system and a closed circuit video camera system to track articles, alert security personnel of theft and permit the display of images for identification and prosecution of perpetrators.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. Apparatus for preventing theft of articles from an enclosure of the type having a lockable access opening, the apparatus comprising:
means for sensing the presence of each of the articles within the enclosure;
means for controlling access to the enclosure to permit removal of an article;
means for identifying an individual attempting to access the enclosure;
means for determining whether the identified individual is authorized to access the enclosure;
means for recording the identity of the authorized individual, the identity of an article removed from the enclosure, and the time that the article was removed from the enclosure;
means for detecting the sale of the removed article, if the removed article is sold; and
means for generating a security alert signal if the removed article is not sold or returned to the enclosure within a given time period after the article was removed from the enclosure.

2. The apparatus of claim 1 further comprising:
video means for recording images of the area proximate the enclosure; and
means for activating said video means to store the images recorded by said video means.

3. The apparatus of claim 1 wherein said article sensing means comprises a RFID tag associated with each article to be monitored, means for identifying each article present in the enclosure by reading the RFID tag associated with the article and means for recoding the identity of an article removed from the enclosure and the time that said article was removed.

4. The apparatus of claim 1 wherein said access controlling means comprises means for locking the enclosure, and means for deactivating said locking means upon determining that on individual is authorized to access the enclosure.

5. The apparatus of claim 4 wherein said locking means is automatically reactivated.

6. The apparatus of claim 1 wherein said identifying means comprises biometric means

7. The apparatus of claim 1 wherein said identifying means comprises a fingerprint reader.

8. The apparatus of claim 1 wherein said means for recording the sale of the removed article comprises means for identifying a removed article when it is sold.

9. The apparatus of claim 1 wherein said security alert signal generating means comprises timing means.

10. The apparatus of claim 1 further comprising means for transmitting said security alert signal to a remote location.

11. The apparatus of claim 1 wherein said recording means further comprises means for identifying an article returned to the enclosure and storing the time that the article was returned.

12. A method for preventing theft of articles from an enclosure of the type having a lockable access opening, the method comprising the following steps:
sensing the presence of each of the articles within the enclosure;
controlling access to the enclosure;
identifying an individual attempting to access the enclosure;
determining whether the individual is authorized to access the enclosure;
recording the identity of the authorized individual, the identity of an article removed from the enclosure, and the time that the article was removed from the enclosure;
recording the sale of the removed article, if the removed article is sold; and
generating a security alert signal if the removed article is not sold or returned to the enclosure within a given time period after the article was removed from the enclosure.

13. The method of claim 12 further comprising the steps of:
recording images of the area proximate the enclosure; and
storing the images recorded.

14. The method of claim 12 wherein the step of sensing the presence of the articles comprises the steps of: associating a RFID tag with each article to be monitored; identifying each article present in the enclosure by reading the RFID tag associated with the article; and recoding the identity of an article removed from the enclosure and the time that said article was removed.

15. The method of claim 12 wherein the step of controlling access to the enclosure comprises the steps of: permitting access to the enclosure upon determining that the individual attempting to access the enclosure is authorized to access the enclosure.

16. The method of claim 15 further comprising the step of automatically relocking the enclosure.

17. The method of claim 12 wherein the step of identifying an individual comprises the step of identifying the individual using biometrics.

18. The method of claim 12 wherein the step of identifying an individual biometrics comprises reading the fingerprint of the individual.

19. The method of claim 12 wherein the step of recording the sale of the removed article includes the step of identifying a removed article that is sold.

20. The method of claim 12 wherein the step of generating a security alert signal comprises the step of monitoring the time from the removal of the article from the enclosure.

21. The method of claim 1 further comprising the step of transmitting the security alert signal to a remote location.

22. The method of claim 12 wherein the step of recording further comprises the step of recording indicia associated with an article returned to the enclosure and the time that the article was returned to the enclosure.
